(19) United States
(12) Patent Application Publication
(10) Pub. No.: US 2009/0153221 A1
(43) Pub. Date: Jun. 18, 2009

(54) POLYPHONIC SOUND GENERATING METHOD

(75) Inventor: Fabien Aeby, Avenches (CH)

Correspondence Address: GRIFFIN & SZIPL, PC, SUITE PH-1, 2300 NINTH STREET, SOUTH, ARLINGTON, VA, 22204, US

(73) Assignee: ASULAB S.A., Marin (CH)

(21) Appl. No.: 11/719,721

(22) PCT Filed: Nov. 14, 2005
(86) PCT No.: PCT/EP2005/012169

§ 371 Date: May 18, 2007

(30) Foreign Application Priority Data
Dec. 1, 2004 (EP) 04028421.8

(51) Int. Cl. G06G 7/14

(52) U.S. Cl. 327/361

(57) ABSTRACT

Method of driving an acoustic piezoelectric transducer (6) characterized in that a signal (8), resulting from the time multiplexing of at least two rectangular periodic signals (12a, 12b) of different frequencies and having pulses of fixed duration and whose duty cycle is less than 0.5, is applied to the terminals of the transducer (6). This signal may result from the time sum of at least two undulating logic signals of different durations.

This is a National Phase Application in the United States of International Patent Application No. PCT/EP2005/012169 filed Nov. 14, 2005, which claims priority on European Patent Application No. 04028421.8, filed Dec. 1, 2004. The entire disclosures of the above patent applications are hereby incorporated by reference.

### FIELD OF THE INVENTION

The present invention concerns a method of generating a polyphonic sound by means of a piezoelectric type acoustic transducer.

### BACKGROUND OF THE INVENTION

Generation of an alarm sound using a piezoelectric vibrator is known, particularly in the wristwatch field. The drive device for this type of vibrator conventionally comprises a piezoelectric element and a booster coil connected in parallel on the collector side of an amplification transistor. When an electric control signal is applied to the base of the transistor in order to make the latter conductive, the current flows through the electric coil in response to the closing of said transistor and the voltage booster is applied to the piezoelectric element. The electric signal applied to the base of the transistor is typically a square-shaped undulating signal. Thus, when the electric signal drops to zero again, the piezoelectric element emits an acoustic signal.

The drawback of this system is that it is only capable of generating a monophonic sound of mediocre musicality and which has virtually no variations.

In order to overcome this drawback, CH Patent No. 630 503 suggests applying to the amplification transistor a signal of fixed frequency but with variable pulse durations. It is possible, by doing so, to alter the timbre of the acoustic signal produced by the piezoelectric element and thus to create the impression of a peal of bells. The sound produced is of higher quality but nonetheless remains a monophonic sound.

A method consisting of applying a train of pulses of variable and decreasing duty cycles to an amplification transistor is also known from CH Patent NO 649 188, the desired objective being to make the acoustic pressure independent of any differences between the features of components used during assembly. Consequently, the method used (pulse duration variation) also does not enable a polyphonic sound to be produced, but only a sound with a variable timbre, which remains monophonic in nature.

It is an object of the present invention to overcome the aforementioned drawbacks in addition to others by providing a method for saving energy and generating a polyphonic sound by means of a piezoelectric type acoustic transducer.

### SUMMARY OF THE INVENTION

The present invention therefore concerns a method of driving a piezoelectric acoustic transducer, characterized in that a logic type undulating signal, with pulses of fixed duration and whose duty cycle is less than 0.5, is applied to the transducer terminals.

Owing to these features, the present invention allows considerable energy savings to be achieved, which proves particularly advantageous if the piezoelectric transducer is fitted to a portable instrument, such as a wristwatch or a mobile telephone, whose energy storage capacity is limited. It has been observed that reducing the duty cycle of the piezoelectric transducer logic control signal, in other words reducing the active phase of the signal and thus the electric power consumption, nonetheless allows acceptable acoustic properties (sound level, tone) to be maintained.

Above all, reduction of the piezoelectric transducer logic control signal duty cycle makes it possible to envisage generating a polyphonic sound.

Thus, in accordance with a complementary feature of the method of the invention, at least two undulating logic signals of different frequencies are simultaneously applied to the terminals of a piezoelectric transducer control system.

Thus, several independent soundtracks are superposed and a polyphonic sound is created. The use of the two frequencies occurs simultaneously, such that the piezoelectric transducer produces two sounds of different frequencies at the same time. In other words, it is possible to multiplex at least two tracks in the time domain owing to the short length of the pulses, i.e. owing to the reduction in the duty cycle which is defined as being the ratio between the duration or length of a pulse and the length of the period of the undulating logic signal, and thus to generate a polyphonic sound.

### BRIEF DESCRIPTION OF THE DRAWINGS

Other features and advantages of the present invention will appear more clearly from the following detailed description of an example implementation of the method according to the invention, this example being given purely by way of non-limiting illustration in conjunction with the annexed drawing, in which:

FIG. 1 is a diagram of a drive circuit for a piezoelectric transducer, and

FIG. 2 shows schematically the temporal multiplexing of two tracks of different frequencies.

### DETAILED DESCRIPTION OF THE ILLUSTRATIVE EMBODIMENTS

The present invention proceeds from the general inventive idea that consists in controlling an acoustic piezoelectric transducer by means of an undulating type logic signal whose pulse duration is fixed and whose duty cycle is less than 0.5. Reducing the pulse duration reduces the active phase of the logic signal and thus the electric power consumption, while keeping acceptable acoustic properties. Moreover, by selecting a duty cycle of less than 0.5, one can simultaneously superpose several tracks of different frequencies and thus produce a polyphonic sound.

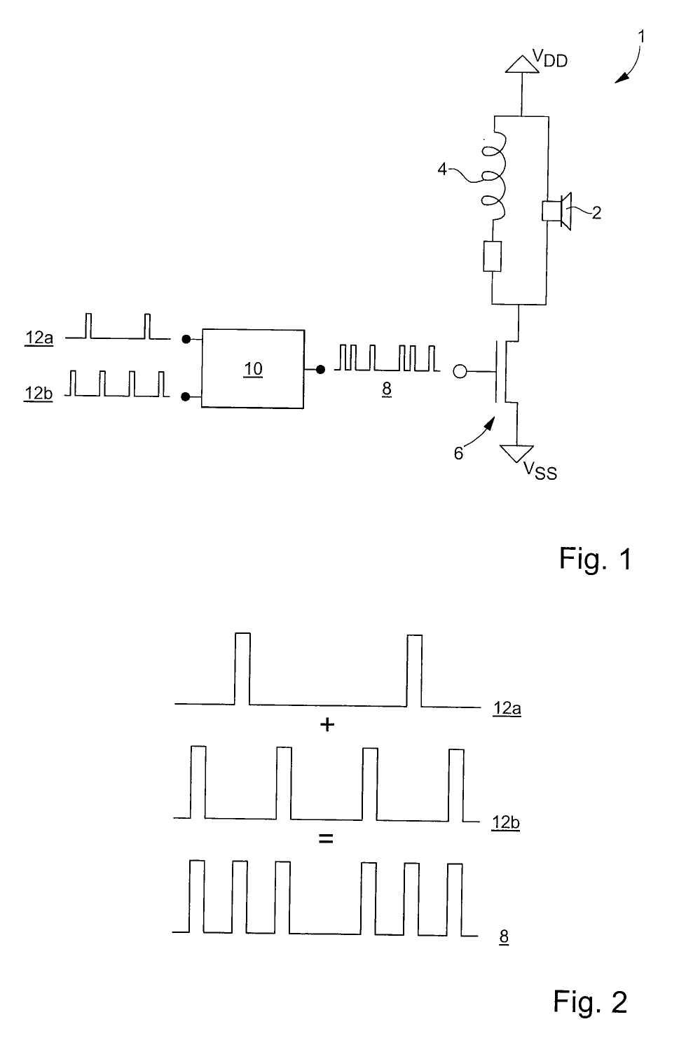

FIG. 1 is a schematic diagram of a drive circuit for a piezoelectric type acoustic transducer. Designated as a whole by the general reference numeral 1, this drive circuit includes a piezoelectric element 2 and a booster coil 4 connected in parallel on the collector side of an amplification transistor 6. When an electric signal 8 is applied to the base of transistor 6, the latter becomes conductive and the current flows through coil 4, causing a voltage boost at the terminals of piezoelectric element 2. The electric signal 8 applied to the base of transistor 6 is typically a rectangular undulating signal whose duty cycle is less than 0.5. Thus, when electric signal 8 drops back to zero, piezoelectric element 2 emits an acoustic signal. It has been observed that a signal of this type whose active phase is reduced reduces electric power consumption while maintaining acceptable acoustic properties for the acoustic signal produced by piezoelectric element 2.

The electric signal 8 applied to the base of transistor 6 is produced by a control circuit or synthesiser 10 of the binary adder type, comprising an OR logic gate. This synthesiser 10 has the ability to multiplex at least two tracks of different frequencies in the time domain, i.e. to make the sum in time of at least two undulating logic signals 12a, 12b as shown in FIG. 2, the control signal 8 applied to the base of transistor 6 being the result of this temporal multiplexing of the two signals 12a, 12b. The means necessary for multiplexing two signals of different frequencies are known to those skilled in the art and will not therefore be described further here.

The logic signals 12a, 12b are characterized by a short pulse duration t comprised between 50 and 300 μs, for example of the order of 100 μs, and by a duty cycle of less than 0.5. It will be recalled that the duty cycle of an undulating type logic signal is determined by the relation between the duration t of a pulse and the period T of a signal period. Thus, a logic signal whose duty cycle is 0.5 is a signal that is at its “1” logic level 50% of the time and which is at its “0” logic level for the remaining 50% of the time.

The logic signals to be multiplexed are produced while maintaining a fixed pulse duration t and while reducing the frequency f, which means decreasing the value of the duty cycle DC. In fact, the duty cycle DC can be expressed as the product between the duration t of a pulse and the frequency f of the logic signal. The more the duty cycle is reduced, the more the spectrum of frequencies transmitted by the piezoelectric element is widened. This widening of the spectrum is accompanied by a redistribution of energy for each of the frequencies of said spectrum, the energy associated with the base frequency decreasing at the expense of higher frequencies. Finally, the duty cycle value DC can be reduced until the majority of the acoustic energy remains within an audible frequency range.

It goes without saying that the present invention is not limited to the embodiment that has just been described and that various simple alterations and variants can be envisaged by those skilled in the art without departing from the scope of the invention as defined by the annexed claims.

1-2. (canceled)

3. The method of driving an acoustic piezoelectric transducer, wherein a signal, resulting from the temporal multiplexing by means of an OR logic gate of at least two rectangular periodic signals of different and offset frequencies is applied across the terminal of the transducer and having pulses of fixed duration and whose duty cycle is less than 0.5, is applied to the terminals of the transducer.

4. Method according to claim 3, wherein the pulse duration of the logic signal is comprised between 50 and 300 μs.
